(19) United States
(12) Patent Application Publication
(10) Pub. No.: US 2008/0138769 A1
(43) Pub. Date: Jun. 12, 2008

(54) Mold Assembly For Manufacturing Tooth And Method For Molding The Same

(76) Inventor: Moo Cheol Lim, Daejeon (KR)

Correspondence Address: GREENBLUM & BERNSTEIN, P.L.C., 1950 ROLAND CLARKE PLACE, RESTON, VA, 20191, US

(21) Appl. No.: 11/813,253

(22) PCT Filed: Jun. 16, 2006
(86) PCT No.: PCT/KR06/02316

§ 371 Date: Jul. 2, 2007

(30) Foreign Application Priority Data
Jul. 20, 2005 (KR) 10-2005-0065813

(51) Int. Cl. A61C 13/20

(52) U.S. Cl. 433/213

(57) ABSTRACT

The present invention relates to a mold assembly for manufacturing tooth and a method for molding the same, comprising a tooth model, a model-binding plate, fixing pins, and a base member, wherein said model-binding plate is a flat plate made of synthetic resin that has a form of which one side has narrow width and the other side has wide width, surface of the side to which said fixing pins are attached being formed with a plurality of concaves; each of said fixing pins is attached at a point corresponding to each center part of the relevant tooth placed at upside of said model-binding plate, pin body of each of said fixing pins being rectangular in cross section, thick at upper part contacting the lower plane of model-binding plate and thin at lower part, and one side of upper part of said pin body being formed with a convex; said base member is formed at its surface with a plurality of convexes each corresponding to each of concaves formed at surface of said model-binding plate; and each of pin insertion holes for receiving said fixing pins at said base member is formed with a concave corresponding to the convex formed at one side of upper part of said fixing pins, whereby improvement is made in structures of model-binding plate and of fixing pins, therefore model-binding plate thereof might be used more effectively, and tight combining might be secured between model-binding plate and tooth model.

### TECHNICAL FIELD

The present invention generally relates to a mold assembly for manufacturing tooth and a method for molding the same, and more particularly to a mold assembly for manufacturing tooth and a method for molding the same, characterized in that improvement is made in the structures of a model-binding plate to be fixedly attached by a tooth model and of fixing pins combined thereto downwardly.

### BACKGROUND ART

A conventional method for molding a mold assembly in use of manufacturing a tooth is disclosed as an example in Japanese Patent Bulletin under No. 2002-95682, which suggests as shown in FIG. 1 a method for molding a tooth model in which a tooth model is attached to the plaster base member 8 that was obtained by injecting an amount of plaster into a mold for molding base member 5, the method for molding a tooth model comprising: a first step of forming a hard-resin plate 1 by installation of a plurality of fixing pins 4 to fix a tooth model to one side of a flat plate; second step of inserting said hard-resin plate 1 into a soft-resin mold 5 for molding base member; third step of injecting plaster into said mold 5; fourth step of taking said plaster base member 8, after said plaster is cured, out of said soft-resin mold 5 for molding base member; and last step of binding a tooth model by a bonding agent to the hard-resin plate 1.

In the prior-art method described as above, however, each of the fixing pins 4 attached at lower plane of the plate 1 combined with the plaster base member 8 takes approximately a cone form that gets finer to its lower end. Therefore, in case when a particular tooth part is to be cut out of the total tooth model and separated from the base member 8 or when the separated tooth is to be fixed again to the original position of said plaster base member 8, it can not be combined tightly as its original status but differs more or less or moves to and fro, which hinders from keeping a high quality of work precision and then from correct realization of patient's tooth profile. In addition, because the interval formed between each of fixing pins 4 is constant with no consideration of patient's tooth profile, the tooth model located at upper plane of the plate 1 in application for each patient's tooth would be different in relative position from the fixing pins 4 located at lower plane of the plate 1. When a particular part of the tooth requiring a treatment is to be cut later, a portion of said fixing pin 4 will be cut unintentionally, which causes a trouble in the next step operation.

### DISCLOSURE OF INVENTION

### Technical Problem

The present invention was contrived to alleviate or solve problems and drawbacks mentioned as above. It is an object of the present invention therefore to provide a mold assembly for manufacturing tooth and a method for molding the same, characterized in that each of the fixing pins placed at lower plane of the model-binding plate is attached at a point corresponding to each center part of the relevant tooth placed at upside of said model-binding plate, which can prevent position of each fixing pin from being discordant relatively with the center position of relevant tooth, whereby it is possible to prevent the relevant fixing pin from being damaged when a particular tooth is to be cut along the cutting line.

In addition, it is another object of the present invention to provide a mold assembly for manufacturing tooth and a method for molding the same, characterized in that improvement is made in structure of fixing pins to be attached at lower plane of the model-binding plate, whereby in case when a particular tooth part is cut for separation from the base member or when the separated tooth is fixed again to its original position of said base member, it can be combined tight easily as the original status, so high quality of work precision can be met and the patient's tooth profile can be materialized more correctly.

### Technical Solution

In order to achieve the objects described as above, a mold assembly for manufacturing tooth according to the present invention is a mold assembly for manufacturing tooth, comprising: a tooth model formed by filling a solidifiable material into a negative impression of patient's tooth, a model-binding plate fixedly attached by a bonding agent to lower part of said tooth model, a plurality of fixing pins attached to lower part of said model-binding plate, and a base member formed with pin insertion holes for receiving said fixing pins, wherein said model-binding plate is a flat plate made of synthetic resin that has a form of which one side has narrow width and the other side has wide width, surface of the side to which said fixing pins are attached being formed with a plurality of concaves; each of said fixing pins is attached at a point corresponding to each center part of the relevant tooth placed at upside of said model-binding plate, pin body of each of said fixing pins having a rectangular cross section, which is thick at upper part contacting the lower plane of model-binding plate and thin at lower part, and one side of upper part of said pin body being formed with a convex; said base member is formed at its surface with a plurality of convexes each corresponding to each of concaves formed at surface of said model-binding plate; and each of said pin insertion holes for receiving said fixing pins is formed with a concave corresponding to the convex formed at one side of upper part of said fixing pins.

It is preferable that each of said fixing pins is formed at center part of each face of the pin body with a groove along its length direction, and each of the pin insertion holes in said base member for receiving each of said fixing pins is formed with bulging parts each corresponding to each groove formed along length direction at said fixing pins.

In addition, the method for molding mold assembly for manufacturing tooth according to the present invention comprises: no. 1 step of preparing a tooth model formed by filling a solidifiable material into a negative impression of patient's tooth; no. 2 step of preparing a model-binding plate of flat plate form consisting of synthetic resin; no. 3 step of forming a model-binding plate attached with a tooth model obtained by attaching the tooth model prepared according to said no. 1 step unto one surface of the model-binding plate prepared according to said no. 2 step; no. 4 step of preparing a plurality of tooth model fixing pins, wherein each of said fixing pins has its pin body of a rectangular cross section, which is thick at upper part contacting the lower plane of model-binding plate and thin at lower part, and wherein said pin body is formed at its center part of each face with a groove along length direction and at one side of upper part with a convex 32; no. 5 step of forming a model-binding plate attached with tooth model fixing pins obtained by attaching a plurality of tooth model fixing pins prepared according to said no. 4 step in a line unto the lower part of the model-binding plate attached with the tooth model prepared according to said no. 3 step, wherein each of said tooth model fixing pins is attached at a point corresponding to each center part of the relevant tooth model; no. 6 step of preparing a mold for molding base member to be used in forming a base member that can combine with or separate from the model-binding plate attached with tooth model fixing pins formed according to said no. 5 step; no 7 step of inserting the model-binding plate attached with tooth model fixing pins prepared according to said no. 5 step into the mold for molding base member prepared according to said no. 6 step, in such a manner that said tooth model fixing pins should be located at upside of said mold for molding base member; no. 8 step of pouring plaster into the mold for molding base member prepared according to said no. 7 step; and no. 9 step of obtaining a mold assembly for manufacturing tooth by taking cured base member out of said mold for molding base member after the plaster poured into the mold for molding base member in said no. 8 step has been cured.

### Advantageous Effect

According to the method for molding a mold assembly for preparing tooth of the present invention, it is possible to prevent the relevant fixing pin from being damaged when a particular tooth is to be cut along a cutting line. And furthermore in case when a particular tooth part is cut for separation from the base member or when the separated tooth is fixed again to its original position of said base member, it can be combined tight easily as the original status, so high quality of work precision can be met and the patient's tooth profile can be materialized more correctly.

### BRIEF DESCRIPTION OF THE DRAWINGS

FIG. 1 is an exploded perspective view for explaining an example of a method for molding a tooth model according to a prior art;

FIG. 2 is an exploded perspective view illustrating combined structure of a mold assembly for manufacturing tooth according to the present invention;

FIG. 3 is an exploded perspective view illustrating main parts dismantled out of the mold assembly for manufacturing tooth according to the present invention;

FIGS. 4 to 6 are perspective views and sectional view of a model-binding plate used in a mold assembly for manufacturing tooth according to the present invention;

FIG. 7 is a perspective view of a fixing pin used in a mold assembly for manufacturing tooth according to the present invention;

FIG. 8 is a perspective view illustrating in separation a mold for molding a base member and a model-binding plate attached by fixing pins which are used in a method for molding a mold assembly for manufacturing tooth according to the present invention;

FIG. 9 is a perspective view illustrating a status when a model-binding plate attached with fixing pins has been inserted into a mold for molding a base member to be used in a method for molding a mold assembly for manufacturing tooth according to the present invention;

FIG. 10 is an explanatory view illustrating a status when plaster is being poured into a mold for molding a base member to be used in a method for molding a mold assembly for manufacturing tooth according to the present invention; and

FIG. 11 is an explanatory view illustrating a status when the mold assembly for manufacturing tooth, after the plaster poured into the mold for molding a base member is cured, has been taken out of the mold for molding a base member in a method for molding a mold assembly for manufacturing tooth according to the present invention.

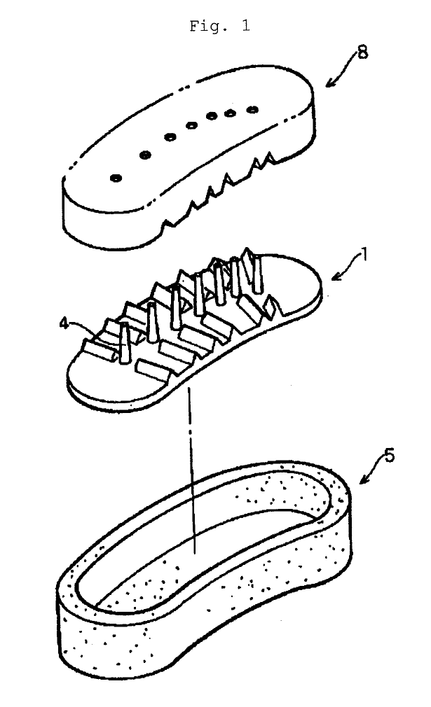

### BEST MODE FOR CARRYING OUT THE INVENTION

Hereinafter, a mold assembly for preparing tooth and a method for molding the same according to preferred embodiments of the present invention will be described in detail with reference to appended drawings.

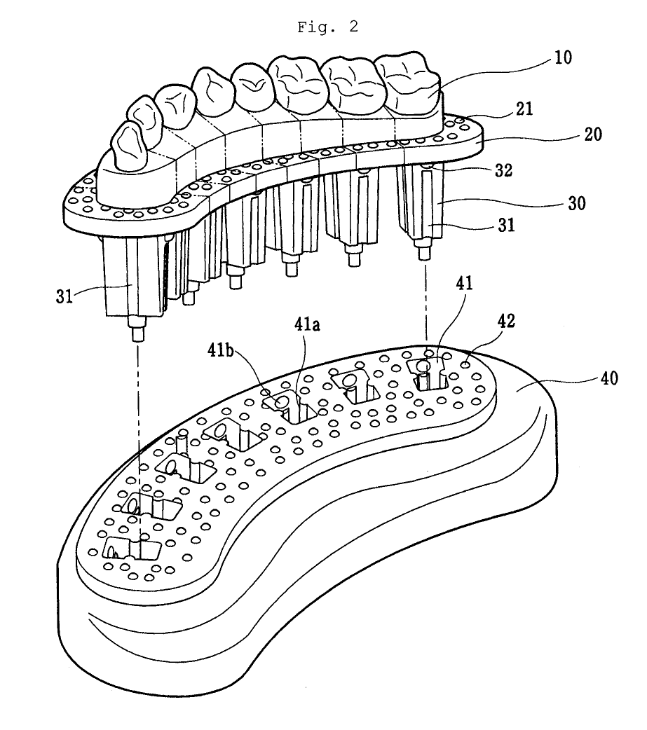

As shown in FIGS. 2 and 3, the mold assembly for preparing tooth according to the present invention comprises a tooth model 10 formed by filling a solidifiable material into a negative impression of patient's tooth, a model-binding plate 20 to be fixedly attached by a bonding agent to lower side of said tooth model 10, a plurality of fixing pins 30 to be attached to lower plane of said model-binding plate 20, and a base member 40 formed with pin insertion holes 41 for receiving said fixing pins 30.

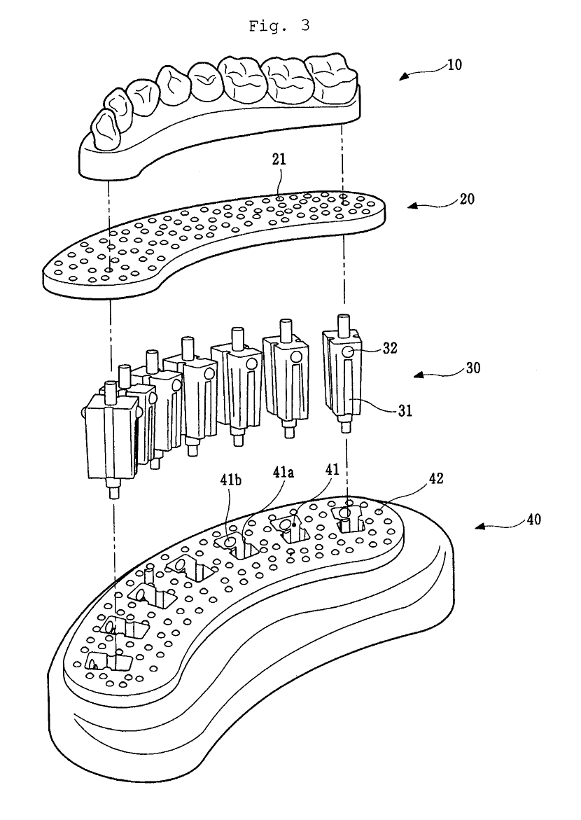

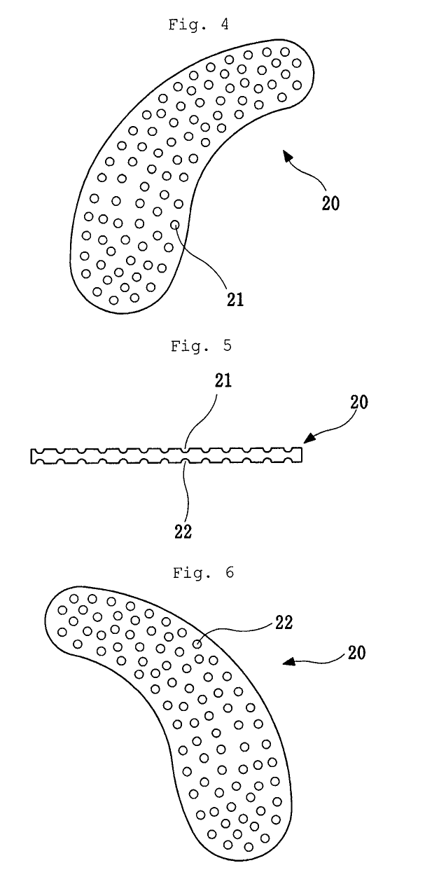

Said model-binding plate 20 is a flat plate made of synthetic resin that has a form of which one side has narrow width and the other side has wide width, attached at its upper plane with a tooth model 10, attached at its lower plane with a plurality of fixing pins 30, and formed at each surface of upper plane and lower plane with a plurality of concaves 21 & 22, referring to FIGS. 4 & 5.

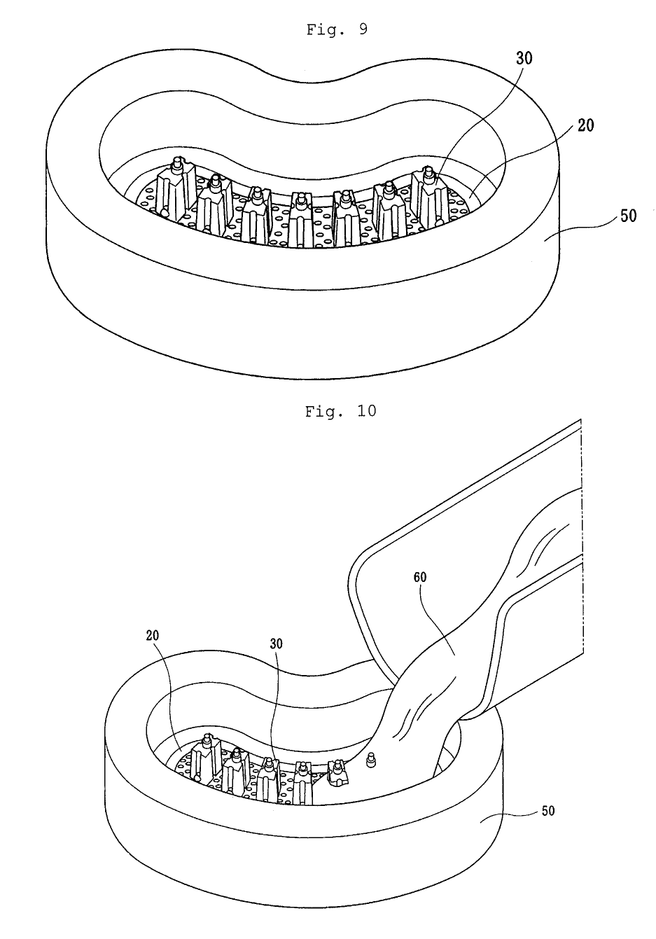

Said concaves 21 & 22 will form a plurality of convexes 42 correspondently on the surface of a base member 40 obtained by curing of plaster 60 poured into a mold for molding base member 50, that will be described later with reference to FIG. 9, after insertion of model-binding plate 20 into said mold for molding 50 in such a manner that said fixing pins 30 are located at upside, whereby a tight combining between said model-binding plate 20 and base member 40 might be maintained on later operation that requires separation or recombining between said model-binding plate 20 and base member 40.

Moreover, a plurality of concaves 21 & 22 are formed on both upper plane and lower plane of said model-binding plate 20, therefore same mold-binding plate 20 can be used in accordance with the type of tooth model to right or left direction irrelevant to the direction of use of tooth model 10 whether it is formed for right use or left use. That is to say, in case when the tooth model 10 is for left use, said model-binding plate 20 according to FIG. 4 might be used; in case when the tooth model 10 is for right use, said model-binding plate 20 might be used in a position upside down according to FIG. 6, therefore one model-binding plate 20 can be effectively changed in direction according to its convenience of usages.

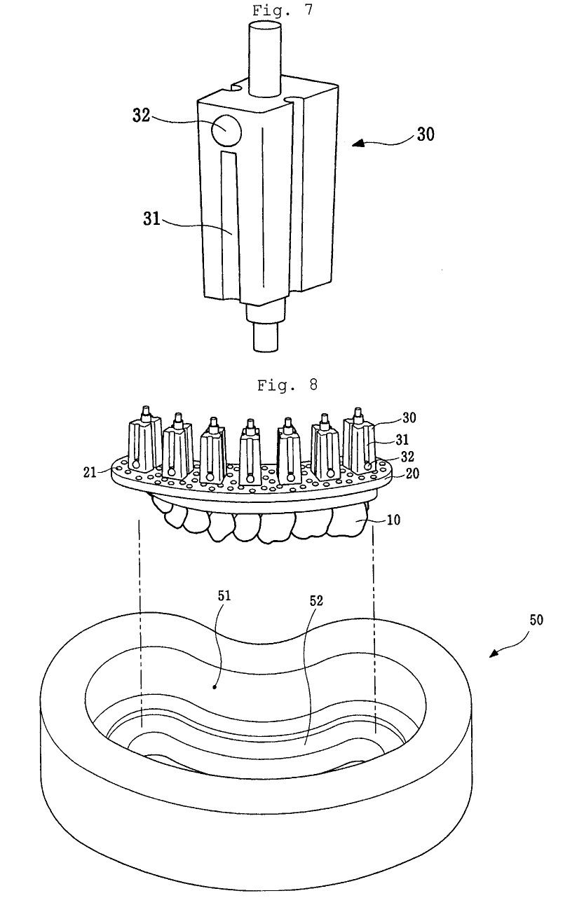

Said fixing pins 30 are attached in plurality at lower plane of said model-binding plate 20. Pin body of each of said fixing pins is rectangular in cross section, referring to FIG. 7, which is thick at upper part contacting the lower plane of the model-binding plate 20 and thin at lower part. Said pin body is formed at its center part of each face with a groove 31 along length direction, and at its one side of upper part with a convex 32.

The grooves 31 each formed at each face of said fixing pins 30 along length direction and the convexes 32 each formed at one side of upper part will form into pin insertion holes 41 (that will be described later with reference to the base member 40) with bulging parts 41a each corresponding to each of said grooves 31 and concaves 41b each corresponding to each of said convexes 32, whereby a tight combining might be maintained with no in-between gap allowed on later operation when it requires repeated process of separation and recombining between said model-binding plate 20 and base member 40.

In order to form a mold assembly for manufacturing tooth comprising such a configuration as described above, in no. 1 step referring to FIG. 3, a tooth model 10 formed is prepared by filling a solidifiable material into a negative impression of patient's tooth.

Then in no. 2 step referring to FIGS. 3 & 4, a model-binding plate 20 in a flat plate form made of synthetic resin for attaching said tooth model 10 is prepared. Said model-binding plate 20 is formed at its surfaces with a plurality of concaves 21 & 22. Such plurality of concaves 21 & 22 enable corresponding plurality of convexes 42 to be formed on upper surface of the base member 40 obtained after curing of plaster 60 poured into a mold for molding a base member 50, which might maintain tight bonding of said model-binding plate 20 with said base member 40.

Then in no. 3 step, the tooth model 10 prepared according to said no. 1 step is attached through a bonding agent or the like unto a surface of the model-binding plate 20 prepared according to said no. 2 step so as to form a model-binding plate 20 attached by tooth model 10.

No. 4 step prepares a plurality of tooth model fixing pins 30 referring to FIG. 7. Pin body of each of said fixing pins 30 has a rectangular cross section which is thick at upper part contacting the lower plane of the model-binding plate 20 and thin at lower part. Said pin body is formed at center part of each face with a groove 31 along length direction and at one side of upper part with a convex 32.

Furthermore in no. 5 step, a plurality of tooth model fixing pins 30 prepared according to said no. 4 step are attached in a line, referring to FIG. 2, unto the lower plane of the model-binding plate 20 attached with tooth model 10 according to said no. 3 step, in such manner that each of said tooth model fixing pins 30 should be placed correspondently with each center part of relevant tooth model 10, thereby a model-binding plate 20 attached by tooth model fixing pins 30 is prepared.

Various methods might be used for attaching each of said tooth model fixing pins 30 to be placed correspondently with each center part of relevant tooth model 10, but as an example, holes of which centers are correspondent to centers of tooth model 10 can be perforated at the lower plane of the model-binding plate 20 attached by tooth model 10, and the fixing pins 30 can be fixedly attached to these holes by a bonding agent or the like.

Then in no. 6 step referring to FIG. 8, a mold for molding base member 50 is prepared to be used for forming a base member 40 that can combine with or separate from the model-binding plate 20 attached by tooth model fixing pins 30 formed at said no. 5 step.

Said mold for molding base member 50 has a hollow 51 formed therein with a sill 52. Into this sill 52, the model-binding plate 20 attached by the tooth model fixing pins 30 formed in no. 5 step is to be inserted in such a manner that the fixing pins 30 should be located at upside. The depth of the hollow portion formed in lower part of said sill 52 should be at least more than the tallest height of the tooth model 10, and the depth of the hollow portion formed in upper part of said sill 52 should be equal to or larger than the length of said fixing pins 30.

In no. 7 step referring to FIG. 9, the model-binding plate 20 attached by tooth model fixing pins 30 prepared as in said no. 5 step is inserted into the mold for molding base member 50 prepared according to said no. 6 step, in such a manner that said tooth model fixing pins 30 are located at upside of said mold for molding base member 50.

In no. 8 step referring to FIG. 10, plaster 60 is poured into said mold for molding base member 50 prepared according to said no. 7 step. It is preferable at this stage before the plaster 60 is poured into said mold for molding base member 50 that release agent should be applied at lower plane of said model-binding plate 20 or around said fixing pins 30 and inside the hollow 51 of mold for molding base member 50. Such an application of release agent enables the base member 40 after the plaster 60 has been cured to be separated easily from said mold for molding base member 50.

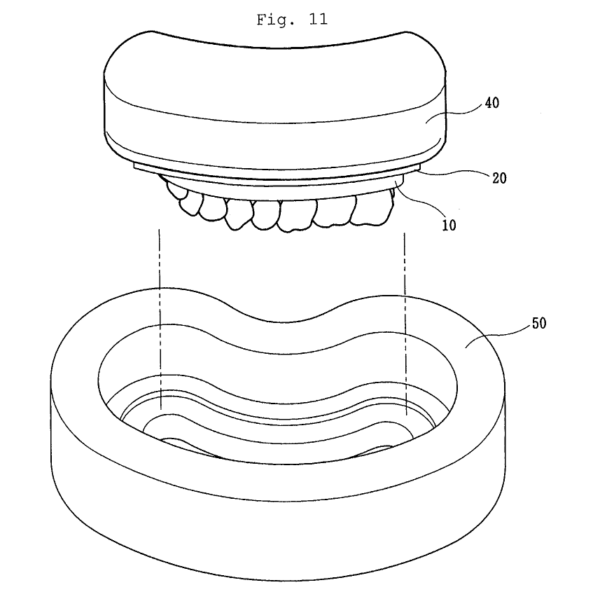

At last in no. 9 step referring to FIG. 11, after the plaster 60 poured in mold for molding base member 50 according to said step no. 8 is cured, the cured base member 40 is taken out of said mold for molding base member 50 to obtain finally a desired mold assembly for manufacturing tooth.

While the present invention has been described herein with reference to the preferred embodiments thereof illustrated as appended drawings, it will be apparent to those skilled in the art that various modifications, variations and equivalent embodiments or examples can be made therein without departing from the spirit and scope of the invention. Therefore, it is intended that the present invention covers also those modifications, variations and equivalent embodiments or examples of this invention that come within the scope of the appended claims and their equivalents.

### INDUSTRIAL APPLICABILITY

According to the method for molding a mold assembly for preparing tooth of the present invention, which is characterized in that each of the fixing pins 30 placed at lower plane of the model-binding plate 20 is attached at a point corresponding to each center part of the relevant tooth placed at upside of said model-binding plate 20, it is possible to prevent position of each fixing pin 30 from being discordant relatively with the center position of relevant tooth, and thus also to prevent the relevant fixing pin 30 from being damaged when a particular tooth is to be cut along a cutting line. Since pin body of each of said fixing pins 30 is rectangular in cross section, thick at upper part contacting the lower plane of model-binding plate 20 and thin at lower part, and is formed at its center part of each face with a groove along its length direction, in case when a particular tooth part is cut for separation from the base member 40 or when the separated tooth is fixed again to its original position of said base member 40, it can be combined tight as the original status, so high quality of work precision can be met and the patient's tooth profile can be materialized more correctly.

What is claimed is:

1. A mold assembly for manufacturing tooth, comprising: a tooth model formed by filling a solidifiable material into a negative impression of patient's tooth, a model-binding plate fixedly attached by a bonding agent to lower part of said tooth model, a plurality of fixing pins attached to lower part of said model-binding plate, and a base member formed with pin insertion holes for receiving said fixing pins, wherein
Said model-binding plate is a flat plate made of synthetic resin that has a form of which one side has narrow width and the other side has wide width, surface of the side to which said fixing pins are attached being formed with a plurality of concaves;
Each of said fixing pins is attached at a point corresponding to each center part of the relevant tooth placed at upside of said model-binding plate, pin body of each of said fixing pins having a rectangular cross section, which is thick at upper part contacting the lower plane of model-binding plate and thin at lower part, and one side of upper part of said pin body being formed with a convex;
Said base member is formed at its surface with a plurality of convexes each corresponding to each of concaves formed at surface of said model-binding plate; and
Each of said pin insertion holes for receiving said fixing pins is formed with a concave corresponding to the convex formed at one side of upper part of said fixing pins.

2. The mold assembly for manufacturing tooth according to claim 1, wherein each of said fixing pins is formed at center part of each face of the pin body with a groove along its length direction, and wherein each of the pin insertion holes in said base member for receiving each of said fixing pins is formed with protruding parts each corresponding to each groove formed along length direction at said fixing pins.

3. A method for molding mold assembly for manufacturing tooth, comprising:
No. 1 step of preparing a tooth model formed by filling a solidifiable material into a negative impression of patient's tooth;
No. 2 step of preparing a model-binding plate of flat plate form consisting of synthetic resin;
No. 3 step of forming a model-binding plate attached with a tooth model obtained by attaching the tooth model prepared according to said no. 1 step unto one surface of the model-binding plate prepared according to said no. 2 step;
No. 4 step of preparing a plurality of tooth model fixing pins, wherein each of said fixing pins has its pin body of a rectangular cross section, which is thick at upper part contacting the lower plane of model-binding plate and thin at lower part, and wherein said pin body is formed at its center part of each face with a groove along length direction and at one side of upper part with a convex 32;
No. 5 step of forming a model-binding plate attached with tooth model fixing pins obtained by attaching a plurality of tooth model fixing pins prepared according to said no. 4 step in a line unto the lower part of the model-binding plate attached with the tooth model prepared according to said no. 3 step, wherein each of said tooth model fixing pins is attached at a point corresponding to each center part of the relevant tooth model;
No. 6 step of preparing a mold for molding base member to be used in forming a base member that can combine with or separate from the model-binding plate attached with tooth model fixing pins formed according to said no. 5 step;
No. 7 step of inserting the model-binding plate attached with tooth model fixing pins prepared according to said no. 5 step into the mold for molding base member prepared according to said no. 6 step, in such a manner that said tooth model fixing pins should be located at upside of said mold for molding base member;
No. 8 step of pouring plaster into the mold for molding base member prepared according to said no. 7 step; and
No. 9 step of obtaining a mold assembly for manufacturing tooth by taking cured base member out of said mold for molding base member after the plaster poured into the mold for molding base member in said no. 8 step has been cured.
